(19) United States
(12) Patent Application Publication
(10) Pub. No.: US 2016/0044867 A1
(43) Pub. Date: Feb. 18, 2016

(54) BLOWER ATTACHMENT FOR A LAWNMOWER

(71) Applicant: Clint P. Martin, Grand Rapids, MI (US)

(72) Inventor: Clint P. Martin, Grand Rapids, MI (US)

(21) Appl. No.: 14/736,886

(22) Filed: Jun. 11, 2015

Related U.S. Application Data
(60) Provisional application No. 62/037,638, filed on Aug. 15, 2014.

(51) Int. Cl. A01D 42/06; A01G 1/12; F04D 29/42; F04D 29/62; F04D 17/08; F04D 25/02

(52) U.S. Cl. CPC A01D 42/06; F04D 17/08; F04D 25/02; F04D 29/422; F04D 29/626; F04D 29/4213; A01G 1/125

(57) ABSTRACT

A blower attachment for a lawnmower. The blower attachment includes an impeller and a shroud that are attachable to the lawnmower deck or undercarriage. The shroud includes a disc-shaped bottom portion defining a reduced-diameter opening. The impeller is centrally positioned over the reduced-diameter opening. Rotation of the impeller draws air through the reduced-diameter opening before being discharged from the lawnmower for the removal of debris from a lawn surface.

### BACKGROUND OF THE INVENTION

The present invention relates to a lawnmower attachment, and in particular, a lawnmower attachment that converts a lawnmower into a leaf blower.

Leaf blowers are known in the art, and provide a lawn tool that propels air out of a nozzle or other restricted opening to move yard debris. Leaf blowers can include an electric motor or a gasoline motor in a self-contained handheld unit or backpack unit. Larger units can be mounted on wheels, and are sometimes referred to as “walk-behind-blowers.” While widely accepted among commercial lawn care operators, these units are not without their associated costs, and are not commonly found among residential users.

More recently, aftermarket lawnmower conversion kits are known to provide a disc-shaped impeller to convert a lawnmower into a leaf blower. The disc-shaped impeller can be joined to the blade attachment portion of a lawnmower, replacing the rotary cutting blades. Rotation of the impeller propels air outwardly from the side of the lawnmower. However, aftermarket lawnmower conversion kits have not been effective and have not been widely adopted. Accordingly, there remains a continued need for an improved aftermarket lawnmower conversion kit that leverages the economy of a conversion kit over the expense of a separate leaf blower.

### SUMMARY OF THE INVENTION

A blower attachment for a lawnmower is provided. The blower attachment includes an impeller and a shroud that are attachable to the lawnmower deck or undercarriage. The shroud includes a bottom portion defining a reduced-diameter opening. The impeller is centrally positioned over the reduced-diameter opening. Rotation of the impeller draws air through the reduced-diameter opening before being discharged from the lawnmower for the removal of debris from a lawn surface.

In one embodiment, the reduced-diameter opening is less than the outer diameter of the impeller. For example, the reduced-diameter opening is less than one half of the diameter of the impeller in some embodiments, while in other embodiments the reduced-diameter opening is less than one-third of the diameter of the impeller. A discharge chute is tangentially aligned with the impeller for the discharge of air over a lawn surface. The reduced-diameter opening can include a screen or a grate to prevent the inflow of rocks, sticks, or other objects into the lawnmower.

In another embodiment, a blower assembly is provided. The blower assembly includes a lawnmower and a blower attachment. The blower attachment includes a shroud that is joined to the lawnmower to define an impeller housing therebetween. An impeller is positioned within the impeller housing to draw air upwardly through an air inlet and outwardly through an air outlet. The air inlet includes a reduced-diameter opening that is less than the outermost diameter of the impeller. The lawnmower includes height-adjustable wheels to elevate the air inlet over the lawn surface. The air outlet includes a discharge chute that extends tangentially and down from the impeller housing to blow air over a lawn surface for the removal of yard waste.

These and other advantages and features of the invention will be more fully understood and appreciated by reference to the description of the current embodiments and the drawings.

### BRIEF DESCRIPTION OF THE DRAWINGS

FIG. 1 is a bottom plan view of a lawnmower including a blower attachment in accordance with one embodiment of the present invention.

FIG. 2 is cross-sectional side view of the lawnmower and blower attachment of FIG. 1.

### DESCRIPTION OF THE CURRENT EMBODIMENTS

The current embodiments relate to a blower attachment for a lawnmower. The current embodiments generally include an impeller and a shroud having a reduced-diameter opening for controlling the flow of air into the blower attachment.

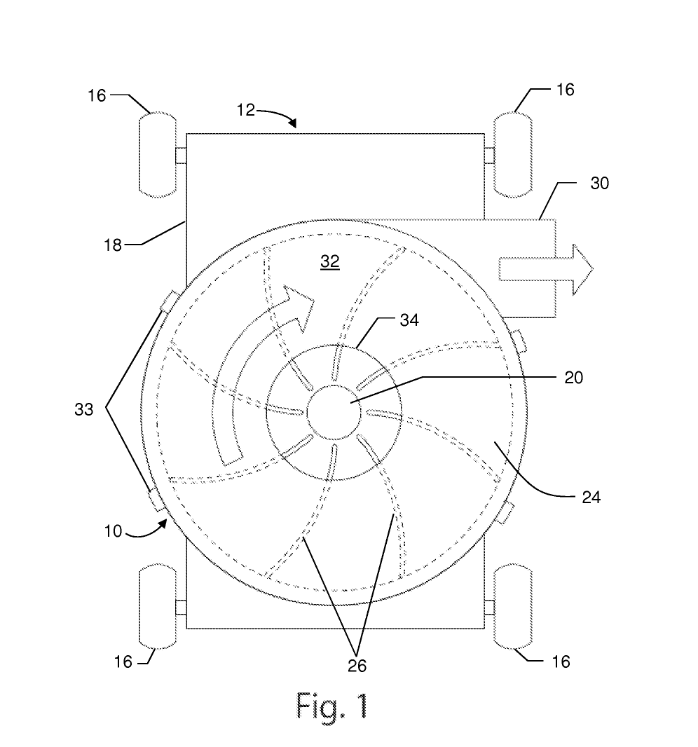

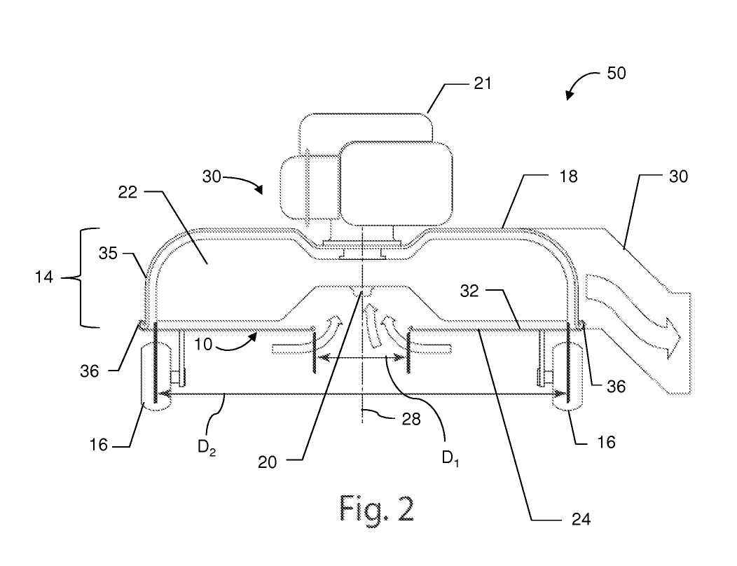

Referring now to FIGS. 1-2, a blower attachment in accordance with one embodiment is illustrated and generally designated 10. As explained more fully below, the blower attachment 10 is configured for attachment to a lawnmower 12, thereby converting the lawnmower into a walk-behind-blower. The lawnmower 12 generally includes a cutting deck 14 supported above a lawn by a plurality of height-adjustable wheels 16. The cutting deck 14 includes a housing 18, a mounting bolt 20, and a cutting blade (not shown). A motor 21 is supported above the cutting deck 14 for rotating the mounting bolt 20, and consequently the cutting blade, in either of the clockwise direction or the counter-clockwise direction.

As noted above, the blower attachment 10 includes an impeller 22 and a shroud 24. The impeller 22 can be a radial flow impeller that is secured to the mounting bolt 20. The radial flow impeller 22 includes impeller blades 26 that extend radially outward from the mounting bolt 20. As best shown in FIG. 2, the impeller blades 26 are enlarged at their distal end portions to generally conform to the interior of the cutting deck 14. When secured to the mounting bolt 20, the radial flow impeller 22 is configured to rotate in a plane perpendicular to a lawn surface to thereby accelerate air outwardly from the axis of rotation 28. As indicated by the block arrows in FIG. 2, the accelerated air generates negative air pressure below the cutting deck 14 and positive air pressure at a discharge chute 30, thereby providing a blast of air over the lawn surface.

The shroud 24 is shown in FIGS. 1-2, and includes a generally planar bottom portion 32. The bottom portion 32 is disc-shaped and defines a reduced-diameter opening 34. The reduced-diameter opening 34 includes a diameter D₁ less than the outer diameter D₂ of the impeller 22. For example, the reduced-diameter opening 34 includes a diameter D₁ that is less than one half of the diameter D₂ of the impeller 22 in some embodiments, while in other embodiments the reduced-diameter opening 34 includes a diameter D₁ that is less than one-third of the diameter D₂ of the impeller 22. Though not shown, the shroud 24 can include one or more vertical sidewalls that further enclose the area within the cutting deck 14 and adjacent to the impeller 22.

As also shown in FIGS. 1-2, the bottom portion 32 of the shroud 22 generally defines an outer diameter that is at least slightly greater than the outer diameter D₂ of the impeller 22. The bottom portion 32 terminates in an upwardly-curved lip 36 to attach to the lawnmower housing 18 by interference fit. One or more fasteners 33 can join the shroud 24 to the cutting deck side skirt 35. The fastener 33 can be clamps in some embodiments, while in other embodiments the fasteners can include a nut-and-bolt connection, for example.

The cutting deck 14 and the shroud 24 cooperate to define a housing for the impeller 22. The impeller 22 is centrally positioned within the housing and over the reduced-diameter opening 34. The housing can be raised with adjustment of the wheels 16 to increase the clearance beneath the shroud 24. By increasing the clearance beneath the shroud 24, the impeller 22 can draw more airflow into the impeller chamber. An optional screen or grate can be fitted over the reduced-diameter opening 34 to prevent the injection of rocks, sticks, and other objects into the impeller housing.

As noted above, the discharge airflow is accelerated laterally outwardly through a discharge chute 30. The discharge chute 30 is an integral extension of the shroud 24 in some embodiments, while in other embodiments the discharge chute 30 is separately attachable to the shroud 24 or to the lawnmower cutting deck 14. As shown in FIG. 1 for example, the discharge chute 30 is tangentially aligned with the impeller 22 and extends through an opening in the cutting deck side skirt 35. The discharge chute 30 is also stepped downwardly to align the discharge airflow with the lawn surface.

A method for converting a lawnmower into a walk-behind-blower will now be described. The method generally includes setting the lawnmower 12 on its side and removing the mounting bolt 20. For many lawnmowers, this step can be performed with household tools, for example a socket wrench, while the spark plug (for gas mowers) is removed. Once the mounting bolt 20 is free, the cutting blade can be replaced with the impeller 20. As noted above, the impeller 20 is generally disc-shaped in the present embodiment, having curved impeller blades that are enlarged at their distal end portions to generally conform to the interior of the cutting deck 14. The mounting bolt 20 is reattached, thereby locking the impeller 20 in position. The method then includes securing the shroud 24 to the underside of the cutting deck 14. This step can include positioning the shroud 24 such that the discharge chute 30 is aligned with the opening in the side skirt 35. The curved end portions 36 of the shroud 24 are then snap-fitted to the side skirt 35, optionally with the use of one or more fasteners 33. The method then includes returning the resulting blower assembly 50 to the upright position. Once in the upright position, the wheels 16 can be height-adjusted to elevate the cutting deck 14 above the yard surface. The entire conversion can take only several minutes, without the use of complicating tooling or machinery. Once the conversion is complete, the blower assembly 50 is operable as a walk-behind mower. The motor 21 drives the impeller 22 to generate a discharge blast through the discharge chute 30, which directs the flow of air over the lawn surface. The blower assembly 50 can be converted into a lawnmower in the reverse order of steps. Briefly, the blower assembly 50 is positioned on its side, and the shroud 24 is removed from the cutting deck 14, exposing the impeller 22. The mounting bolt 20 is then removed to allow the swapping out of the cutting blade for the impeller 22. Once the mounting bolt 20 is reattached, the lawnmower is then returned to the upright position, and lowered with adjustment of the wheel height.

The illustrated embodiments therefore provide a blower attachment to convert a lawnmower into a walk-behind-blower, generally with the use of household hand tools. The conversion can take only minutes to perform, optionally with improved flow performance over existing units, and can provide the convenience of a walk-behind-blower without the added expense of a separate, standalone leaf blower.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A blower attachment for a lawnmower comprising:
an impeller attachable to the lawnmower, the impeller including a plurality of blades, the impeller defining an outer impeller diameter; and
a shroud attachable to the lawnmower, the shroud having a bottom portion below the impeller defining an airflow inlet, the airflow inlet having a diameter less than the outer impeller diameter, wherein air is drawn through the airflow inlet in response to rotation of the impeller for discharge from the lawnmower.

2. The blower attachment of claim 1 wherein the shroud includes a discharge chute.

3. The blower attachment of claim 2 wherein the discharge chute extends generally tangentially from the impeller.

4. The blower attachment of claim 1 wherein the bottom portion of the shroud is disk shaped and wherein the airflow inlet is circular.

5. The blower attachment of claim 4 wherein the bottom portion includes an outer diameter that is greater than twice the airflow inlet diameter.

6. The blower attachment of claim 4 wherein the bottom portion includes an outer diameter that is approximately three times the airflow inlet diameter.

7. The blower attachment of claim 1 wherein the shroud is attachable to the lawnmower housing along a lower periphery of the lawnmower housing.

8. A blower assembly for blowing yard debris comprising:
a lawnmower having a lawnmower housing and a blade attachment portion; and
a blower attachment including:
an impeller removably coupled to the blade attachment portion,
a shroud removably coupled to the lawnmower housing, wherein the shroud includes a planar bottom portion defining a reduced-diameter opening that underlies a portion of the impeller, wherein air drawn is drawn through the reduced-diameter opening in response to rotation of the impeller for discharge from the blower attachment.

9. The blower assembly of claim 8 wherein the blower attachment includes a discharge chute extending generally tangentially from the impeller.

10. The blower assembly of claim 8 wherein the planar bottom portion is disk shaped and wherein the reduced-diameter opening is circular.

11. The blower assembly of claim 10 wherein the diameter of the planar bottom portion is greater than twice the diameter of the reduced-diameter opening.

12. The blower assembly of claim 10 wherein the diameter of the planar bottom portion is greater than three times the diameter of the reduced-diameter opening.

13. The blower assembly of claim 8 wherein the shroud is attachable to the lawnmower housing along a lower periphery of the lawnmower housing.

14. A ducted impeller system for blowing debris, the ducted impeller system being adaptable for mounting to a lawnmower cutting deck, comprising:
an underbody shroud attachable to the lawnmower housing, the underbody shroud including a disc-shaped bottom portion defining an airflow inlet through a central portion thereof, the underbody shroud further including a discharge chute; and
an impeller centrally positioned over the airflow inlet, wherein the underbody shroud and the lawnmower housing cooperate to form an impeller chamber, and wherein air is drawn into the impeller housing through the airflow inlet and discharged from the impeller housing through the discharge chute with rotation of the impeller to blow debris from a lawn surface.

15. The ducted impeller system of claim 14 further including at least one of a grate or a screen seated over the airflow inlet.

16. The ducted impeller system of claim 14 wherein the airflow inlet is circular and defines an airflow inlet diameter.

17. The ducted impeller system of claim 16 wherein the airflow inlet diameter is less than the outer diameter of the impeller.

18. The ducted impeller system of claim 16 wherein the airflow inlet diameter is less than one half of the outer diameter of the impeller.

19. The ducted impeller system of claim 16 wherein the airflow inlet diameter is less than one third of the outer diameter of the impeller.

20. The ducted impeller system of claim 14 wherein the underbody shroud is attachable to the lawnmower housing along a lower periphery of the lawnmower housing.
